(19) United States
(12) Patent Application Publication
(10) Pub. No.: US 2016/0224092 A1
(43) Pub. Date: Aug. 4, 2016

(54) APPARATUS AND METHOD FOR DYNAMIC ADJUSTMENT OF POWER SAVING MODALITIES BY TOUCH EVENTS

(71) Applicant: LUCIDLOGIX TECHNOLOGIES LTD., Natanya (IL)

(72) Inventors: Ron Weitzman, Bnei Tzion (IL); Alexandra Goldemberg, Herzliya (IL); Ishay Peled, Kfar Saba (IL); Guy Sela, Tel Aviv (IL); Dvir Rosenfeld, Tel Aviv (IL)

(21) Appl. No.: 15/010,205

(22) Filed: Jan. 29, 2016

Related U.S. Application Data
(60) Provisional application No. 62/110,656, filed on Feb. 2, 2015.

(51) Int. Cl. G06F 1/32; G06F 3/041

(52) U.S. Cl. CPC G06F 1/3231; G06F 3/0416; G06F 1/3265

(57) ABSTRACT

A mobile device includes a touchscreen with a display area and an area to receive a finger touch; a touch sensor to receive a finger touch and provide the touch signal to a control module within the mobile device. The touch signal may one or more of: a static finger touch, a finger touch and a finger slide, a finger slide, a finger slide and a stop finger movement, and a finger slide and a finger up motion from the touchscreen; and the control module includes a state machine programmed to respond to the one or more touch signals to one of: increase the FPS, decrease the FPS, or not change the FPS.

### RELATED APPLICATIONS

This application claims priority to U.S. Provisional Patent Application No. 62/110,656, filed Feb. 2, 2015 and U.S. Provisional Patent Application No. 62/209,416, filed Aug. 25, 2015, the entireties of which are incorporated by reference herein.

### FIELD OF THE INVENTION

The present invention relates to power saving modalities, particularly in connection with use on mobile devices to, among other things, conserve battery power while keeping the user's experience level high.

### BACKGROUND OF THE PRESENT INVENTION

Power saving technologies are known in the art. These power saving technologies are of particular importance in devices that rely on battery power, such as tablets and smartphones. Power saving is important, but perhaps less critical, for devices that rely on the plug-in public utility power.

One known power saving technique is to lower the rate at which frames are presented to the user through a user interface such as a display screen. By lowering the frames per second displayed (hereinafter “FPS”), less power is required over a given period of time and this in turn provides savings in battery drainage. One example in which lowering the FPS may be applicable is a static screen in which the display shows the same scene over a given period of time. Since there is no change in the frame display, it is easy to lower the FPS without there being a detriment to the user's experience. An example on the other end of the spectrum could be a fast-moving video game in which the FPS rate should be kept at a level so that no jittering or latency in the presentation of moving objects occurs.

The desire, then, is to make the presentation appear as “natural” as possible, yet to save battery life and keep the CPU workload reduced to minimize heat buildup in the CPU and in the battery which may be under a heavy load. Certain activities, however, may cause noticeable slowness or jittering in the display of frames. One example may be a finger touch on a touch screen of a smartphone or tablet in a situation in which there has been no activity for a given period of time. Another is a finger touch combined with movement of the finger on the screen after some period of an absence of activity. The desire is that the FPS, which may have been “throttled back” will revert to a high FPS ASAP so that the user's experience is not negative.

Power management in mobile devices is critical due to the limited power stored at any given time in the device's battery. In today's environment, more and more applications and software run on smart phones and this increases power consumption. The present day broadband cell infrastructure has shifted the user bottleneck from available bandwidth to available power.

In the prior art, different methodologies or a mix of methodologies have been implemented to manage, optimize or reduce the power consumption of a mobile device. Among these solutions is a state machine which controls the frames per second (FPS) of an application. The FPS of an application may be reduced, for example, in order to reduce power consumption. However, reduced FPS may negatively affect the user's experience by generating frames having large inter-frame changes or by generating a segmented flow of frames which does not appear smooth to the human eye.

The assignee of the present application, Lucidlogix, has developed a suite of power-saving techniques under the general banner of the “PowerXtend” family of products. These products include several modules that handle apps such as Games, Maps and navigation, Social networking and Web browsers. By their very names one can discern the purpose and focus, by the application, of these products.

### BRIEF DESCRIPTION OF THE DRAWINGS

FIG. 1 illustrates a schematic representation of a computer system that may be implemented in conjunction with the present invention.

FIG. 2 illustrates a schematic representation of a computer screen which may be used in conjunction with the present invention.

FIGS. 3A and 3B illustrate one embodiment of a mobile device in which the present invention may be implemented.

FIG. 4 is a state diagram that illustrates the interaction of touch/non-touch/finger up/motion/motion stopped events.

### SUMMARY

In an aspect, a mobile device includes a touchscreen with a display area and an area to receive a finger touch; a touch sensor to receive a finger touch and provide the touch signal to a control module within the mobile device. The touch signal may one or more of: a static finger touch, a finger touch and a finger slide, a finger slide, a finger slide and a stop finger movement, and a finger slide and a finger up motion from the touchscreen; and the control module includes a state machine programmed to respond to the one or more touch signals to one of: increase the FPS, decrease the FPS, or not change the FPS.

In another aspect, a system includes a touch sensitive surface on a device, the touch sensitive surface producing a touch signal upon interaction with one or more fingers; it also may include one or more processors to receive the touch signal and process the touch signal depending on the type of touch signal; the touch signal may be one or more of: a static finger touch, a finger touch and a finger slide, a finger slide, a finger slide and a stop finger movement, and a finger slide and a finger up motion from the touchscreen; a state machine may be programmed to respond to the one or more touch signals and, one of: increase the FPS, decrease the FPS, and not change the FPS.

In yet another aspect a method of controlling a mobile device may include the steps of: detecting, on a touchscreen having a display, a touch event by one of more fingers. The touch event may be provided to a control module; the control module may be programmed with a state machine to detect one or more of: a static finger touch, a finger touch and a finger slide, a finger slide, a finger slide and a stop finger movement, and a finger slide and a finger movement up from the touchscreen; in response to detecting, the control module causes one of: increasing the FPS, decreasing the FPS, and not changing the FPS.

In yet a further aspect, the method may include the step of providing a touch holdoff period, as well as the further step of determining whether a touch event occurred within or outside of the holdoff period; based on whether within or outside the holdoff period, the FPS is decreased or is not decreased.

In a further aspect, the method may further comprise the step of providing at least two categories of commands with respect to one or more user interactions and wherein a first category of commands causes and increase in FPS and wherein a second category of commands causes the FPS to not be increased.

In yet another aspect, the programmed state machine of the mobile device may operate under one or more of the following rules: every time a finger leaves the screen, when in a ‘No/Static Touch’ state, the PS parameter should change to PS_{Up} for a period of H_{Up}; in the event an additional finger leaves the screen when in ‘Finger Up’ state, the PS parameter should remain to PS_{Up}, and the counter for H_{Up} should be reset; once the holdoff period of H_{Up} is over, the state machine should return to “No/Static Touch’. The PS parameter should return to PS_{Original}; during ‘Finger Up’, in case Motion is detected for 1 or more fingers, ‘Motion’ state should be triggered and PS parameter should change to PS_{Motion}; in ‘Motion’ state, once fingers stop moving, the state machine should go into the ‘Motion Stopped’ mode; once in ‘Motion Stopped’ state, the PS parameter should change to PS_{Motion} for a period of H_{Motion}; in the event an additional finger touches the screen when in ‘Motion Stopped’, the state should remain ‘Motion Stopped’; in the event that a finger leaves the screen when in ‘Motion Stopped’ AND after a period of time defined in TH_{FingerMotion}, state should change to ‘Motion Stopped & Finger Up’. The PS Parameter should change to the minimum value between PS_{Motion} and PS_{Up}, for a period of the maximal time between remaining H_{Motion} and H_{Up}; in the event that Motion starts for 1 or more fingers during ‘Motion Stopped’ or ‘Motion Stopped & Finger Up’ states, the state should change to ‘Motion’; once the holdoff period of H_{Motion} (or maximal time between remaining H_{Motion} and H_{Up}) is over, the state machine should either return to ‘No/Static Touch’ state. The PS parameter should return to PS_{Original}; and, physical keys should be treated the same as Static Touch.

### Detailed Description of a First Embodiment of the Present Invention

The present invention is directed to power saving techniques in the general area of finger touching and movement of the finger(s) on a touchscreen. An assumption may be that the FPS has been throttled back to some level after a period of inactivity, wherein the activity in this example is a touch event. Once a touch of the screen is detected either alone or followed by a finger movement on the screen, the system is made to react, depending sometimes on the nature of the touch activity itself. One example is navigation on a NAV app or program on a device.

When the program is simply generating a set of directions, the frames may be rendered at a more “leisurely” rate since the user will not notice (or care) within reason of the rate of response. In another instance, for example, when the user moves around the map displayed or zooms in and out, latency in display may be noticeable and negatively affect the user's experience. Thus, in these events, the FPS rate may be caused to increase and accelerate for a period of time, likely the period of time the zooming activity occurs and for a predetermined time afterwards. In addition, even after the event or events of movement are completed, the FPS rate may remain for a predetermined period of time at the high level since motion may sometimes occur even after the user's finger leaves the screen or in case the user again (and soon) interacts with the screen. After expiration of the predetermined period of time, the FPS rate may revert to the lower, pre-event rate.

The present invention provides a touch event software mitigation solution and includes a touch event interception software module, a touch event processing software mechanism, a touch event software handler in which the touch event interception software module invokes the touch event software handler. A database for each app or installed program may be included. This database includes predetermined FPS rates for different apps or programs in a “lookup” type table. One example of the manner in which an Android framework processes input events may be seen as follows. Obviously, in a different OS input events may be implemented in a different manner The Android framework processes input events in the following manner

At the lowest layer, the physical input device produces signals that describe state changes such as key presses and touch contact points. The device firmware encodes and transmits these signals in some way such as by sending USB HID reports to the system or by producing interrupts on an 12C bus.

The signals are then decoded by a device driver in the Linux kernel. The Linux kernel provides drivers for many standard peripherals, particularly those that adhere to the HID protocol. However, an OEM must often provide custom drivers for embedded devices that are tightly integrated into the system at a low-level, such as touch screens.

The input device drivers are responsible for translating device-specific signals into a standard input event format, by way of the Linux input protocol. The Linux input protocol defines a standard set of event types and codes in the linux/input.h kernel header file. In this way, components outside the kernel do not need to care about the details such as physical scan codes, HID usages, 12C messages, GPIO pins, and the like.

Next, the Android EventHub component reads input events from the kernel by opening the evdev driver associated with each input device. The Android InputReader component then decodes the input events according to the device class and produces a stream of Android input events. As part of this process, the Linux input protocol event codes are translated into Android event codes according to the input device configuration, keyboard layout files, and various mapping tables.

Finally, the InputReader sends input events to the InputDispatcher which forwards them to the appropriate window.

When the touch event processing software mechanism intercepts a touch event, the software selects one of the predetermined FPS rates depending on the type of touch event and sets the FPS rate accordingly. Thus, different types of touch activities may have different FPS rates and such different activities may switch from a slower to a higher FPS rate (or vice versa) at different rates of time changes. A frame drop occurs in either in the Surfaceflinger process or in the application itself. The decision of whether to drop a frame or not to drop occurs every time a frame is ready to be drawn and displayed. The foregoing relates to and is known as the “FPS Reduction Solution”.

In addition to the FPS Reduction Solution just described, the present invention incorporates further decision tree events in the determination of whether to drop a frame or not. These may include configurable parameters, including: (a) a touch feature enable parameter which is an “on/off” event; and (b) a touch holdoff parameter, which is enabled based upon the time in milliseconds.

When it is time to decide whether to draw and display the next frame or simply drop it, the touch events are accounted for as follows:

1. If no touch event occurred within the holdoff (i.e. if X₁ is the time the event occurred and X₂ is the time needed to draw the frame, then X₂−X₁>holdoff) or touch feature was configured to “off”, the FPS Reduction Solution described above is invoked.

2. If, however, a touch event occurred within the holdoff (i.e. if X₁ is the time the event happened and X₂ is the time needed to draw the frame, then X₂−X₁, </=holdoff) and the touch feature was configured to “on”, the device's decision on drawing a frame is invoked.

In addition, in the present invention, an enhanced event interception integration feature may be included (naïve). In this manner, a touch velocity vector may function as follows: when an input event arrives, its distance and the time differences from the last input event is calculated. Let t_{d} be the time difference and pos_{d} be the velocity vector. When additional input events occur, their position and time difference from the last input event are used to calculate a new velocity vector. Then, the velocity vector is normalized and this becomes the vertical component v. A configurable frame rate is set per vertical component range with specific frame rate configuration per range. For example, the frame rate may be set at 30 FPS if 35>v>30.

When it is time to decide whether to draw the next frame, the above ranges and v are used to make the decision. If touch is enabled, the ranges are used to decide if the next frame will be drawn or not. On the other hand, if touch is disabled, the device's native frame decision is used.

By implementing the above techniques, for example, a slow speed scrolling, which in the past may have caused a raising of the FPS, is avoided. In addition, a Push To Talk (PTT) activation in the past may have caused the FPS to be raised (when such raising in clearly not needed) is avoided in the present invention. By measuring the velocity/acceleration of the user inputs, “false” FPS-raising events are avoided. In general, it has been found that low velocity and/or low acceleration of user input events do not need to have the FPS raised, whereas higher velocity and/or acceleration rates suggest a higher FPS. By recognizing the velocity and/or acceleration, the next frame may be predicted. Other examples are as follows.

In the event a user scrolls through the screen, the desire is to make sure no frame is dropped so that a fluent user experience continues. If the holdoff is set to about 2 seconds and the touch feature discussed above is enabled, no frame will be dropped while the user is scrolling

In, for example, a WeChat walkie-talkie application, the user may desire to send an audio message, and as with a walkie-talkie, may press a button on the smartphone screen, speak the message or other communication, and then release the button on completion. In this type of event, this scenario leads to no FPS decrease in the naïve case, although the desired behavior is to keep dropping frames. There will be no real change in the visual effect since the touch event is purely static. Utilizing the techniques discussed above, one may define a velocity (v) range v₁<K such that K is the maximum velocity still considered static. When the user touches the screen to send an audio message, then v<K so matching it with the latter rule, the FPS may drop, resulting in better power conservation.

### Detailed Description of a Second Embodiment of the Present Invention

According to another aspect of the invention, a state machine may be configured to reduce the FPS of an application at certain events but still make the reduction in the user's experience bearable. Such a system may also be configured to detect when a user interacts with the system. When a user interacts with the system, the assumption is that latency is no longer bearable and the system will adjust the FPS in order to meet the user's expectations for higher responsiveness. One example for a user interaction with the system is described when a user touches the screen and scrolls down, the screen moves down. In order to make this movement of the screen smooth and not appear erratic or segmented, the FPS of the application will be increased to a bearable level of an about 30-60 FPS.

Moreover, it is known in the prior art that fast finger movement on the screen will cause the screen to move down in a decreased speed for a hold off period even after the finger is off the screen. At least in some applications, the faster the finger moves, the faster the screen scrolls down and the longer the hold off period becomes. This is very similar to the physical momentum a physical object will experience due to an applied force for a limited period of time. According to this aspect of the invention, the system may be set to apply a decreased FPS but be configured to identify a user interaction. Once a user interaction is identified, the system may temporarily increase the FPS in order to improve the user's experience. Moreover, the system may do so not only during the time a user physically interacts with the screen, as in this example with the finger, but also during the hold off time in which the screen continues to move after such a physical interaction had been terminated. It should be mentioned that in this application, for simplicity, a user interaction is exemplified by one of more fingers which are pushed down to the screen, move along the screen or pushed up the screen. However, this invention is not limited to any specific finger interaction with the system or to any other specific interaction with system. Alternative interactions may also be, as a non-limiting examples, fingers which move above the screen without touching the screen, eye or gaze detection, voice interaction or any other way in which a user may interact with the system.

According to another aspect of the invention, a user's interaction with the system may cause frame updating. For example, pushing a logic button on the screen or a physical button on the phone like the back bottom or home button, may cause the system to show on the screen or on one part of the screen, a new frame of information. Typically, the new frame will move and overlap the old frame by a movement from the side, above or below the old frame. This transaction of frame will take place after the user interacted with the system e.g. after finger is up. According to this aspect of the invention, a system which implements a reduced FPS and is also configured to detect user interaction and to increase FPS as a result of a user interaction may be set to keep the state of the system in an increased FPS state even after finger up has been detected for a hold off period so that any frame transaction will take place smoothly and not appear segmented. After such a hold off period, the system may go back to a power save mode by reducing FPS.

According to yet another aspect of the invention, the system may be configured to designate type I commands and type II commands. Type I commands are commands which are considered as user interactions which require higher responsiveness and therefore any user interaction through these type I commands will cause an increase in FPS during the interaction and for a hold off period thereafter. Home buttons, back buttons (whether physical or logical) or any button on the screen which causes update on the screen or a transaction of screens are non-limiting examples of type I commands. Type II commands are commands for which the system will not increase FPS even if implemented. A volume button is one example of a type II command.

As mentioned above, a hold off period may be associated with certain user interactions for which an increased FPS may be maintained. Also as mentioned above, there are currently applications which already are implemented such as the continuation of screen movement even after a user interaction had been terminated. Since there is one hold off period defined in the system subject to this invention and there is another hold off period of the native application, there could be four mechanisms according to this invention to define the hold off periods in which we keep a higher FPS: (a) analyzing the hold off period of the native application off line and practice the same hold off period in the system subject to this invention; (b) defining one or more fixed hold off periods for the system subject to this invention to practice and ignoring the real hold off period of the native application; (c) providing an algorithm which runs real time and detects screen movement and frame updates; as long as the screen moves or updates, the high FPS hold off period is maintained; (d) creating a hand shake with the native application which will feed the system subject to this invention with the value of the native application hold off time so that the system will be able to practice the same hold off time to get an optimal overlap.

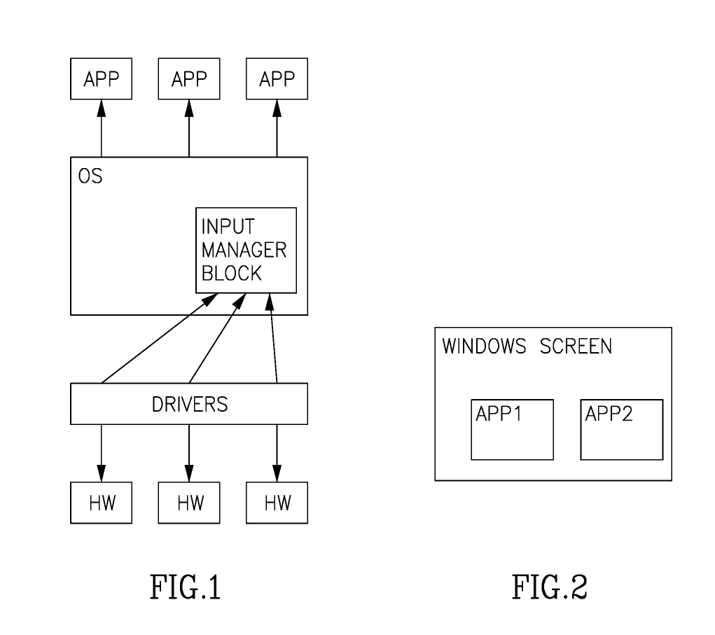

As seen in FIG. 1 each hardware (HW) when operated sends signal to the driver, the driver sends inputs to the operating system (OS) updating the system that a certain operation has been performed (e.g., mouse sends an input that right button was pressed). The OS checks which application is registered to get this input. The application which is registered to receive this input will receive it from the OS from an input block module which manages inputs to the applications. For example, FIG. 2 illustrates a Windows screen in which application 1 is located on one area of the screen and application 2 is located in a different area on the screen. When a user clicks a mouse button for example, while the mouse is over application 1, the OS makes sure this command is sent to application 1. According to another aspect of the invention, a system is configured to save power by reducing the FPS and is also configured to identify input commands which are sent from the OS to an application based on a user's interaction with the system. According to this aspect of the invention, the system is further configured to increase the FPS of the registered application or for the entire screen so that any update or change on the screen will appear smoothly and not appear erratic or segmented. Moreover, in the event there is any hold off period associated with such a user interaction in which a user's experience may be improved by keeping the FPS at a higher rate, the system may keep the FPS at a higher rate.

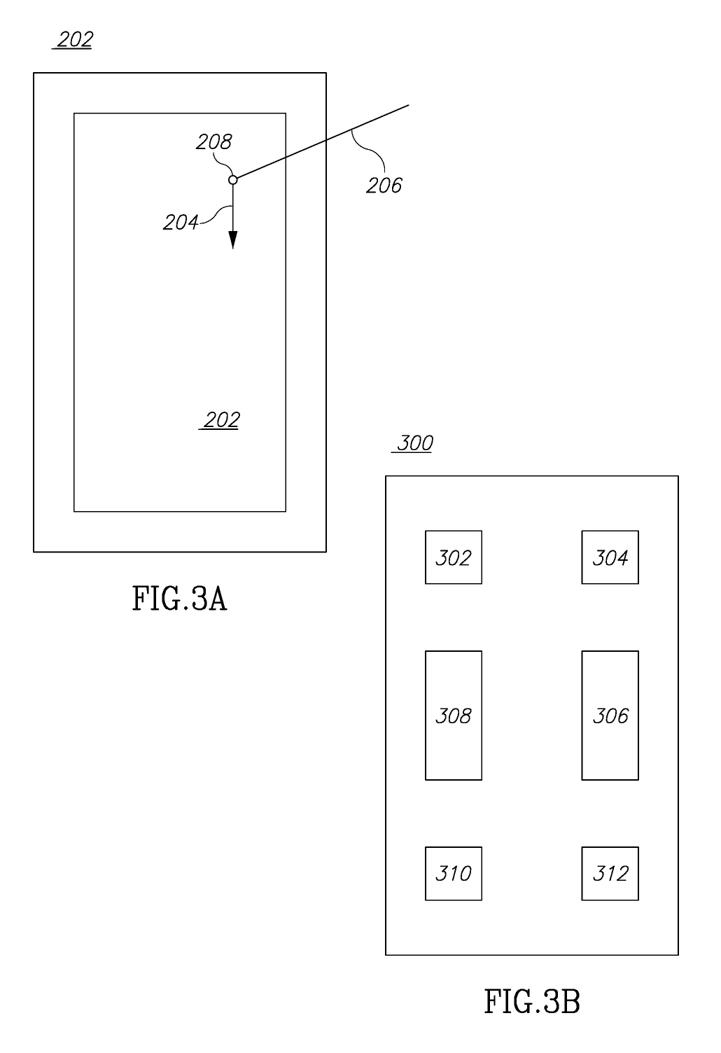

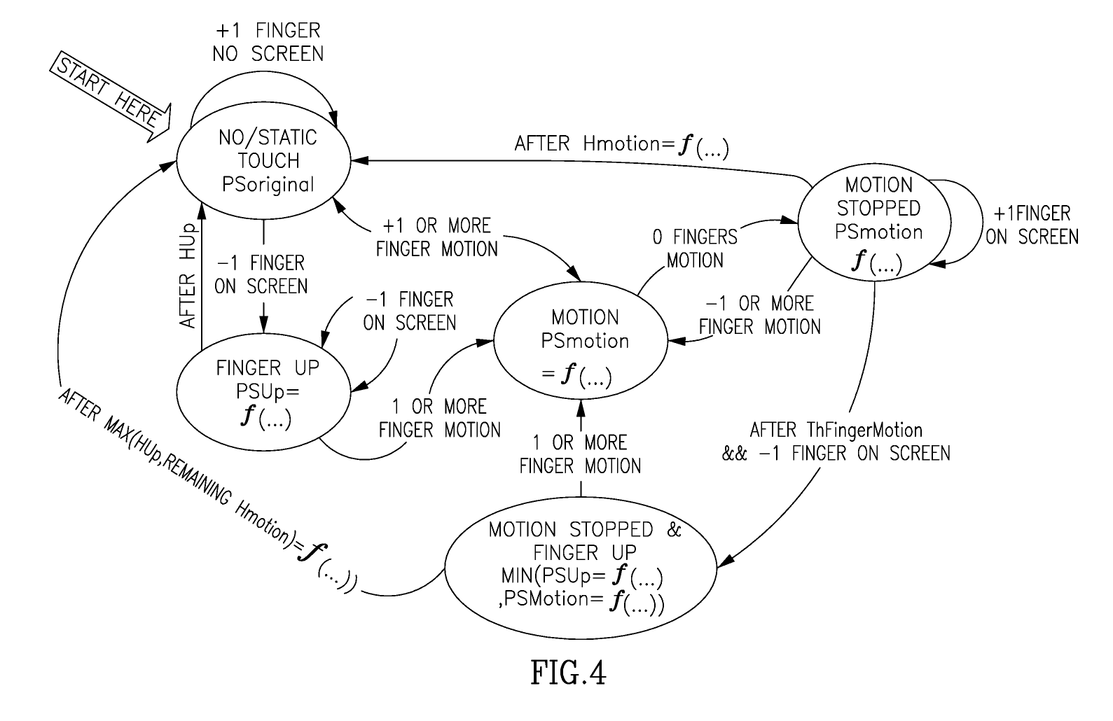

Turning now to FIGS. 3A and 3B, these figures illustrate one embodiment of an exemplary device in which the present invention state machine, discussed below, may be implemented. In FIG. 3A, a mobile phone or other mobile device 200 includes a display touch screen 202 onto which a user, with one or more fingers 206, may touch the screen at 208 and may additionally move the finger on the screen in a direction 204. It is to be understood that such motion, while shown in FIG. 3A as being in a straight line in the direction of the arrow 204, it may involve any other type of motion and may involve more than one finger.

FIG. 3B illustrates one embodiment of hardware/firmware/software that may be used to implement the operation of the present invention. The device 300 may include one or more processors and one or more GPUs 302. In addition, a programmed control module 304 may be provided to handle various touch/no touch/move finger(s) inputs. A memory 306 may be provided to contain instructions to govern the operation of the state machine to be described below. A user interface 310 may be provided as well as one or more touch sensors 312 to detect finger touch/touches and finger movement(s) and convey such touch/touches and movement(s) for processing by the processor(s) 302 to control FPS depending on the nature of the touch and/or finger movement events.

According to yet another aspect of the invention, a system may be configured to switch a displaying mode from mode A once the system is in state A to mode B once the system is in state B. A system state may be changed, for example, due to a user interaction or due to any intrinsic reason of the application or the operating system. The assumption is that a user may expect different user experiences in each of these modes. Stated another way, a user's level of bearable displaying thresholds or parameters, such as resolution or FPS, may be different at these two different states.

FIG. 3 herein is a state diagram which illustrates the interaction of touch/non-touch/finger up/motion/motion stopped events. The interaction of the events of FIG. 3 are as follows:

First, the following definitions are pertinent to the state diagram of FIG. 3:
No/Static Touch—No fingers on screen or >0 fingers without Motion.
This includes touching physical buttons such as the ‘Back’ (←) button.
It should be possible to configure which physical buttons are considered static touch. For example—exclusion of the volume button should be possible.
Finger Up—1 or more fingers stopped touching the screen/keys.
Motion—Any period of time in which the user moves one or more fingers touching the screen.

Motion Stopped—No fingers are moving on the screen, following Motion.
Motion Stopped & Finger Up—A ‘Finger Up’ event that occurs during ‘Motion Stopped’.

Characteristics and Rules Behavior:

1. Every time a finger leaves the screen, when in ‘No/Static Touch’ state, the PS parameter should change to PS_{Up} for a period of H_{Up}.

2. In the event an additional finger leaves the screen when in ‘Finger Up’ state, the PS parameter should remain to PS_{Up}, and the counter for H_{Up} should be reset.

3. Once the holdoff period of H_{Up} is over, the state machine should return to “No/Static Touch’. The PS parameter should return to PS_{Original}.

4. During ‘Finger Up’, in case Motion is detected for 1 or more fingers, ‘Motion’ state should be triggered and PS parameter should change to PS_{Motion}.

5. In ‘Motion’ state, once fingers stop moving, the state machine should go into the ‘Motion Stopped’ mode.

6. Once in ‘Motion Stopped’ state, the PS parameter should change to PS_{Motion} for a period of H_{Motion}.

7. In the event an additional finger touches the screen when in ‘Motion Stopped’, the state should remain ‘Motion Stopped’.

8. In case a finger leaves the screen when in ‘Motion Stopped’ AND after a period of time defined in TH_{FingerMotion}, state should change to ‘Motion Stopped & Finger Up’. The PS Parameter should change to the minimum value between PS_{Motion} and PS_{Up}, for a period of the maximal time between remaining H_{Motion} and H_{Up}.

9. In the event that Motion starts for 1 or more fingers during ‘Motion Stopped’ or ‘Motion Stopped & Finger Up’ states, the state should change to ‘Motion’.

10. Once the holdoff period of H_{Motion} (or maximal time between remaining H_{Motion} and H_{Up}) is over, the state machine should either return to ‘No/Static Touch’ state. The PS parameter should return to PS_{Original}.

11. Physical keys should be treated the same as Static Touch.
a. It should be possible to configure which keys are used as input and which are ignored.
b. Configuration should be possible through Lucid XML files, see tag <ButtonUpBehavior> below.

Where:
PS_{Original} may be defined per app/per power state, or per module/per power state (under the <default> tag). This is identical to definition of customer XML files in v3.1.
PS_{Motion}, H_{Motion}, PS_{Up} and H_{Up} may be defined per app or per module (under the <default> tag).
Configuration for physical keys:
To be managed under the <ButtonUPBehavior> tag.
Tag should be available in Lucid or customer configuration files.
The BtnUPDefault parameter may be either:
1—Set all buttons to be used as input.
0—Set all buttons not to be used as input.
The <key_event> tag will denote exceptions from the default behavior. It will contain an attribute specifying the key code (CODE), and a value, BtnUpBehavior, specifying the override:
1—Set the button to be used as input.
0—Set the button not to be used as input.

Customer configuration XML file example for default behavior:

<client>

<default>

<touch_enable>TouchEN</touch_enable>
<touch_holdoff>HMotion</touch_holdoff>
<touch_ps_param>PSMotion</touch_ps_param>
<touch_hup>HUp</touch_hup>
<touch_psup>PSUp</touch_psup>

</default>

</client>
<client>

<apps>
<com.app.example>

<touch_enable>TouchEN</touch_enable>
<touch_holdoff>HMotion</touch_holdoff>
<touch_ps_param>PSMotion</touch_ps_param>
<touch_hup>HUp</touch_hup>
<touch_psup>PSUp</touch_psup>

<com.app.example>
</apps>

</client>
<default>

<th_finger_motion>ThFingerMotion</th_finger_motion>
<ButtonUpBehavior>

<default>BtnUpDefault </default>
<key_event id=”CODE”>BtnUpBehavior</key_event>
...

</ButtonUpBehavior>

</default>
<app>

<ButtonUpBehavior>

<default>BtnUpDefault</default>
<key_event id=”CODE”>BtnUpBehavior</key_event>
...

</ButtonUpBehavior>

</app>

Notes:

1. Same as for other configuration parameters, in case the specific app behavior is not defined, the module should use the default values defined in the <default> tag.

2. XML priorities are defined for the entire <ButtonUpBehavior> node. This means that once the <ButtonUpBehavior> tag is found with the highest priority, all other lower priority <ButtonUpBehavior> tags are ignored.

What we claim is:

1. A mobile device comprising:
a touchscreen having a display area and an area to receive a finger touch;
a touch sensor to receive a finger touch and provide the touch signal to a control module within the mobile device;
wherein the touch signal is one or more of: a static finger touch, a finger touch and a finger slide, a finger slide, a finger slide and a stop finger movement, and a finger slide and a finger up motion from the touchscreen; and,
wherein the control module includes a state machine programmed to respond to the one or more touch signals to one of: increase the FPS, decrease the FPS, or not change the FPS.

2. A system comprising:
a touch sensitive surface on a device, the touch sensitive surface producing a touch signal upon interaction with one or more fingers;
one or more processors to receive the touch signal and process the touch signal depending on the type of touch signal:
wherein the touch signal is one or more of: a static finger touch, a finger touch and a finger slide, a finger slide, a finger slide and a stop finger movement, and a finger slide and a finger up motion from the touchscreen;
a state machine programmed to respond to the one or more touch signals and, one of: increase the FPS, decrease the FPS, and not change the FPS.

3. A method of controlling a mobile device comprising the steps of:
detecting, on a touchscreen having a display, a touch event by one of more fingers;
the touch event being provided to a control module;
wherein the control module is programmed with a state machine to detect one or more of: a static finger touch, a finger touch and a finger slide, a finger slide, a finger slide and a stop finger movement, and a finger slide and a finger movement up from the touchscreen;
and wherein, in response to detecting, the control module causes one of: increasing the FPS, decreasing the FPS, and not changing the FPS.

4. The method of claim 3, further comprising the step of providing a touch holdoff period, and the further step of determining whether a touch event occurred within or outside of the holdoff period; and, based on whether within or outside the holdoff period, decreasing or not decreasing the FPS.

5. The method of claim 3, further comprising the step of providing at least two categories of commands with respect to one or more user interactions and wherein a first category of commands causes and increase in FPS and wherein a second category of commands causes the FPS to not be increased.

6. The mobile device of claim 1, wherein the programmed state machine operates under one or more of the following rules:
every time a finger leaves the screen, when in a ‘No/Static Touch’ state, the PS parameter should change to PS_{Up} for a period of H_{Up};
in the event an additional finger leaves the screen when in ‘Finger Up’ state, the PS parameter should remain to PS_{Up}, and the counter for H_{Up} should be reset;
once the holdoff period of H_{Up} is over, the state machine should return to “No/Static Touch’. The PS parameter should return to PS_{Original};
during ‘Finger Up’, in case Motion is detected for 1 or more fingers, ‘Motion’ state should be triggered and PS parameter should change to PS_{Motion};
in ‘Motion’ state, once fingers stop moving, the state machine should go into the ‘Motion Stopped’ mode;
once in ‘Motion Stopped’ state, the PS parameter should change to PS_{Motion} for a period of H_{Motion};
in the event an additional finger touches the screen when in ‘Motion Stopped’, the state should remain ‘Motion Stopped’;
in the event that a finger leaves the screen when in ‘Motion Stopped’ AND after a period of time defined in TH_{FingerMotion}, state should change to ‘Motion Stopped & Finger Up’. The PS Parameter should change to the minimum value between PS_{Motion} and PS_{Up}, for a period of the maximal time between remaining H_{Motion} and H_{Up};
in the event that Motion starts for 1 or more fingers during ‘Motion Stopped’ or ‘Motion Stopped & Finger Up’ states, the state should change to ‘Motion’;
once the holdoff period of H_{Motion} (or maximal time between remaining H_{Motion} and H_{Up}) is over, the state machine should either return to ‘No/Static Touch’ state. The PS parameter should return to PS_{Original}; and,
physical keys should be treated the same as Static Touch.
